(19) United States
(12) Patent Application Publication
(10) Pub. No.: US 2006/0242027 A1
(43) Pub. Date: Oct. 26, 2006

(54) Internet-based duty-free goods electronic commerce system and method

(76) Inventor: Leon Falic, Bal Harbour, FL (US)

Correspondence Address: MANUEL VALCACEL;c/o GREENBERG TRAURIG, P.A., 1221 BRICKELL AVENUE, MIAMI, FL, 33131, US

(21) Appl. No.: 11/410,340

(22) Filed: Apr. 24, 2006

Related U.S. Application Data
(60) Provisional application No. 60/674,608, filed on Apr. 25, 2005.

(51) Int. Cl. G06Q 30/00

(52) U.S. Cl. 705/26; 705/27

(57) ABSTRACT

An Internet-based duty-free goods electronic commerce system comprising an Internet communications server for Internet-based communications with system users, flight data (or other travel means data) sources, duty-free merchants and other system participants, a system application server comprising computer processor means at the system-end for processing communications among the Internet communications server and system-end databases, software applications and other system-end elements; data storage means communicating with said applications server storing databases with system user data, duty-free rules and restrictions data applicable to various arrival and departure points, and information about duty-free goods available for purchase at various arrival and departure points; and system software applications providing a graphical user interface for system users to input data and transact with the system. A method of engaging in electronic commerce relating to duty-free goods is also disclosed and claimed.

### BACKGROUND OF THE INVENTION

A. Technical Field

The present invention relates to methods and systems for engaging in electronic commerce. More particularly, the present invention relates to a comprehensive Internet-based duty-free goods electronic commerce method and system.

B. Background

When foreign products are imported for sale in another country, the government of the country into which the products are imported generally imposes an import duty or tariff, a fee which the local merchant inevitably passes on to the consumer as part of the purchase price for the products, in addition to the merchant's retail mark-up over the wholesale price paid by the merchant. Because the resulting price to the consumer is higher for imported goods as a result, the consumer is theoretically given an incentive to buy domestic goods, which further the domestic government's interest of protecting domestic trade and businesses.

Duty-free shopping usually involves consumers purchasing foreign-made goods in foreign countries as international travelers when they depart from a foreign country, without having an import duty imposed at the time of purchase. The consumer must then carry the purchased goods with him or her out of the foreign country, and then declare the purchased goods in a declaration to their home country's customs agency when returning to their home country with the purchased goods. The home country generally imposes restrictions on the types of products, quantities and total purchase amounts of products purchased by consumers in a foreign country on a duty-free basis and later brought by the consumer into the consumer's home country.

In the U.S. for example, there is currently an $800 per person limit on duty-free goods brought in by consumers from foreign countries. The duty-free allowances and other restrictions vary widely from country to country. If the applicable limit is exceeded, the consumer must pay an import duty on the excess amount purchased and imported into the consumer's home country.

Duty-free stores are stores, usually located in airports, ship ports, land border regions and other entryways into a country, which are licensed by the local government to import goods into the country without paying a duty on them. Since they are not paying a duty, they can sell the products at a lower price than regular merchants, which don't have such an exemption. The duty exemption applies to the merchant, not the consumer. If a consumer was to come home and buy a product in a duty-free store located in his or her home country, the consumer would not have to pay any duty because the consumer did not import the product. However, if the consumer purchases a product at a duty-free store in a foreign country, the consumer will, except for purchases within the prescribed duty-free allowance of the home country, have to pay an import duty when bringing the product back home from the foreign country. Obviously, if the home country's duty-free stores could sell to anyone, the country's domestic consumers would go to their home country's duty free stores to purchase goods without being charged an import duty, to the great disadvantage of regular domestic merchants that have to pay import duties. For this reason, duty free shops are carefully controlled to make sure that items purchased at duty-free stores are purchased by, and leave with, a departing international traveler. Although, in the U.S., departing international travelers are not subject to customs inspections when leaving, in many other countries, government officials commonly check departing passengers' documents and items they are carrying to verify that they are departing, and if they have duty free purchases, they are monitored to make sure they indeed depart the country. If they do not depart and seek to remain in the foreign country, the consumer must pay the foreign country's import duty on purchases at the foreign duty-free stores. Duty-free stores usually request that consumers show their departing travel boarding pass either as a condition of entering the duty-free store or as a condition for making a purchase therein. Additionally, when an authorized purchase is made the consumer is generally not allowed to carry it out himself/herself. Instead, the consumer is given a receipt and the purchased goods are put in a carry bag with a copy of the receipt and a duty-free store employee later delivers the carry bag with the purchased goods to the departure point when the consumer boards the departing airline, ship or other vehicle. In airports, this usually involves delivery of the carry bag to the consumer at the actual departing flight gate's jet bridge after the consumer has presented his or her boarding pass and is in the jet bridge beyond the point of return, to eliminate the possibility that the purchasing consumer can give the purchased goods to anyone not departing the country of purchase.

Because of the nature of duty-free purchasing, which usually involves a hurried purchase by a traveling consumer on his or her way to a departing flight from a foreign country at a licensed duty-free store located in the airport or other port or point of departure from the foreign country, there is usually very little opportunity for comparison shopping to make sure the duty-free purchase is really a good deal after all. Consumers seeking to make smart duty-free purchases need a way to identify what foreign-made goods interest them, a way to determine what restrictions there are in purchasing and bringing back with them such goods from the particular country of departure into their particular country of arrival, a way to identify where in the country of departure they can find such goods and purchase them in a convenient manner, preferably at or near their departure point, so they can minimize the inconvenience of having to carry the purchased goods with them while they are traveling, and a way to comparison shop beforehand to make sure they are actually getting a bargain after all the effort involved. The present invention provides an Internet-based system and method that addresses these needs.

### SUMMARY OF THE INVENTION

The present invention is an Internet-based system and method for purchasing duty-free goods. The description of the invention is primarily in the context of air travel as the means for traveling, and the descriptions therefore refer to airports, jetways or jetbridges, and flight data. However, the invention is not limited to implementations involving air travel, and can be used in sea travel involving ports, land travel at border crossings or other international travel means, and no limitations regarding means for traveling are intended or should be interpreted. The system of the present invention, in a preferred embodiment, comprises: one or more Internet communications servers for Internet-based communications with system consumer users, travel transportation method (e.g., flight data, cruise data, land travel method) data sources, duty-free goods merchants and other system participants, one or more system application servers comprising computer processor means at the system-end for processing communications to and from said Internet communications server and system-end databases, software applications and other system-end elements; one or more data storage devices communicating with said applications server which store one or more databases storing data regarding system users, duty-free rules and restrictions data applicable to various travel arrival and departure points, and information about duty-free goods available for purchase at various travel arrival and departure points; one or more system software applications run by said applications server computer processor and optionally with an image server that provides a master file of high resolution images of duty-free store products providing image configuration and integration with screen content provided by the system's one or more application servers, providing a graphical user interface with content for system users, both consumers and duty-free store merchants, to input data and transact with the system, enabling consumer users to order and pay for duty free goods available from said duty-free goods merchants for pickup or delivery at designated duty-free goods merchant locations at designated departure/arrival points in compliance with applicable duty-free rules and restrictions; a user-end input device communicating with said Internet communications server for system users to input data regarding user identification, travel transportation method (e.g., flight, cruise, land travel method) information, arrival and departure points, information pertaining to duty-free goods to be purchased, and payment form information. Travel transportation method data sources, such as, for example, flight date/time and gate information sources, can be housed within the system as part of its databases or can be accessed externally, to verify and or cross/reference information entered by the consumer system-users. They can be optionally excluded as well. Duty-free store merchants can also be users of the system, communicating with the system's Internet communications server via a merchant-end input device to provide their duty-free goods inventory data for review by consumer users, engage in electronic commerce with such consumers and create online promotions for duty-free products. These features can also be provided via “web services” utilizing Extensible Markup Language (“XML”) protocols and technologies. Web services is a standard programming software protocol based on standards created by the World Wide Web Consortium for working among businesses, developers and programs through open protocols, languages and application programming interfaces such as XML, Simple Object Access Protocol (“SOAP”), Web Services Definition Language (“WSDL”) and Universal Description, Discovery and Integration (“UDDI”).

Additionally, the invention is a method for engaging in electronic commerce involving duty-free goods, comprising the following steps: receiving and verifying a consumer users' travel information, such as, in the context of air travel, the consumer's identification data, flight number, date and time of departure and departure and arrival points; identifying one or more duty-free stores located at or near the consumers' flight departure or arrival point (as applicable); identifying the duty-free restrictions applicable to purchases from said duty-free stores for importation into the consumers' home country or other arrival point; providing information regarding the duty-free goods available for purchase from said one or more duty-free stores; processing consumer duty-free goods purchase selections and payment for same; and fulfilling said purchases, whether by delivery of the purchased goods to the purchaser at the purchaser's departure point jet way or by pickup by the purchaser at the designated duty-free store, or by other permitted means. Purchases can be made either for pickup or delivery on departure to a foreign country or on departure from a foreign country to the consumer's home country.

The present invention provides users of the system, which can be both travelers and duty-free stores, with a system that addresses all of their duty-free needs comprehensively, efficiently and cost effectively. Because it is preferably web-based, it requires no software downloading by users and is accessible by users on demand 24 hours a day, seven days a week. Users, preferably already have JAVA and Flash software capability available as part of their end communications device, such as, without limitation, a personal computer. In a preferred embodiment, the present invention provides constantly updated data and reports as duty-free restrictions and inventory levels at stores change.

In preferred embodiments, the invention takes the form of a website accessed by users, providing a graphical user interface or dashboard providing an interface to system software applications that allow airline travelers using the system to identify their airline flights, their departure and arrival points, review and select duty-free goods for purchase in compliance with the duty-free restrictions applicable at the duty-free stores located at the users' travel points, and arrange for pickup or delivery of the purchased goods at their designated departure points in compliance with the applicable duty-free purchasing restrictions.

The present invention utilizes cutting edge technology to deliver the duty-free shopping advantage to international travelers before they even begin their travels. The present invention functions as a duty-free shopping portal that provides an online e-commerce system which can be independently managed by each of the participating duty-free stores, giving them a complete e-commerce capability at minimal cost and maximum ease. Additionally, an administrator can be designated to manage multiple stores. This gives the stores' customers the ability to expedite their duty-free shopping, while allowing the stores to showcase their top selling items. The duty-free merchant's storefront can be managed manually through an easy-to-use web interface, or automatically by using industry standard web services. International shoppers and duty-free store merchants can display information in different languages and prices in the currency of their choice. This allows for better sales in international markets and enriches the shopping experience. In addition, the present invention can be integrated with travel e-commerce systems to offer travel-related goods and services to system users (e.g., car rentals, hotel reservations, weather reports, etc.). More importantly, such strategic alliances and integrations allow the traveler to start duty-free shopping at the time of purchasing the ticket. Consumers can comparison shop and make informed purchasing decisions, including where, and when, such as, for example, at the last departing flight from a U.S. airport in a multi-leg trip, to purchase duty-free goods. The system is designed to interface with industry standard programs so that the standard programs will accept input from the invention and return the desired information. In this manner, the system incorporates improvements in information and techniques as they occur.

Once a traveler has booked a flight, the traveler can set up an account on the present invention website and then enter his or her flight information. The present invention utilizes real-time lookups with airline flight or other travel transportation, registration systems such as Sabre and OAG, to validate and find the duty-free stores that can service the traveler/consumer based on the flight information. The present invention's shopping cart will flag for the consumer the rules and regulations applicable to the consumer's purchases. These rules and regulations, along with product and corporate information systems, are tightly integrated using real-time bi-directional lookups. Purchases are verified through a payment gateway, funds are paid to the store when the duty-free goods are delivered to the traveler. Payment can be made by credit card, debit card, prepaid card, electronic funds transfer or other means. The card or other payment means information can optionally be presented simply for identification and verification purposes, with actual payment being completed at the duty-free store at the time of order pickup or delivery. The store is notified of the order and the goods prepared for delivery to the traveler at the duty-free store or delivered to the traveler at the jetway gate. In-store kiosks can be used to inform travelers that a duty-free store is enabled to the system and educate travelers about the benefits of the system. The present invention can even notify travelers about upcoming promotional events and confirm order information by e-mail, over the Internet or to their cell phone via text messaging. Consumers can comparison shop more easily because they have the ability to browse duty-free store offerings without being rushed to make it to a departing homebound flight.

Through the use of technologies such as ColdFusion and Java, the present invention utilizes rapid development cycles with the performance and scalability of object-oriented programming. Use of Macromedia Flash offers a rich and unique shopping experience across multiple platforms such as cell phones, pda's and mobile pc's. The present invention incorporates a secure environment with maximum failover and redundancy to achieve a 99.9% uptime. This allows for continuous shopping from all over the globe. Webtrends enterprise level solutions are also preferably integrated into the system site so that the present invention always knows what the traveler wants. Duty-free stores enabled by the present invention benefit from unprecedented methods of advertising thanks to the use of image servicing technology, which creates on-the-fly dynamic advertising controlled by the store.

### BRIEF DESCRIPTION OF THE DRAWINGS

All of the referenced drawings form part of this specification and depict preferred embodiments of the invention, but it is to be understood that the invention is not limited to the embodiments depicted therein.

FIG. 1 depicts the system hardware architecture used in one embodiment of the present invention.

FIG. 2 presents a flow-chart of the process flow of the present invention.

FIG. 3 depicts a sample system consumer user log-in screen.

FIG. 4 depicts a sample new system user registration screen.

FIG. 5 depicts a sample user log-in screen for users that are already registered with the system.

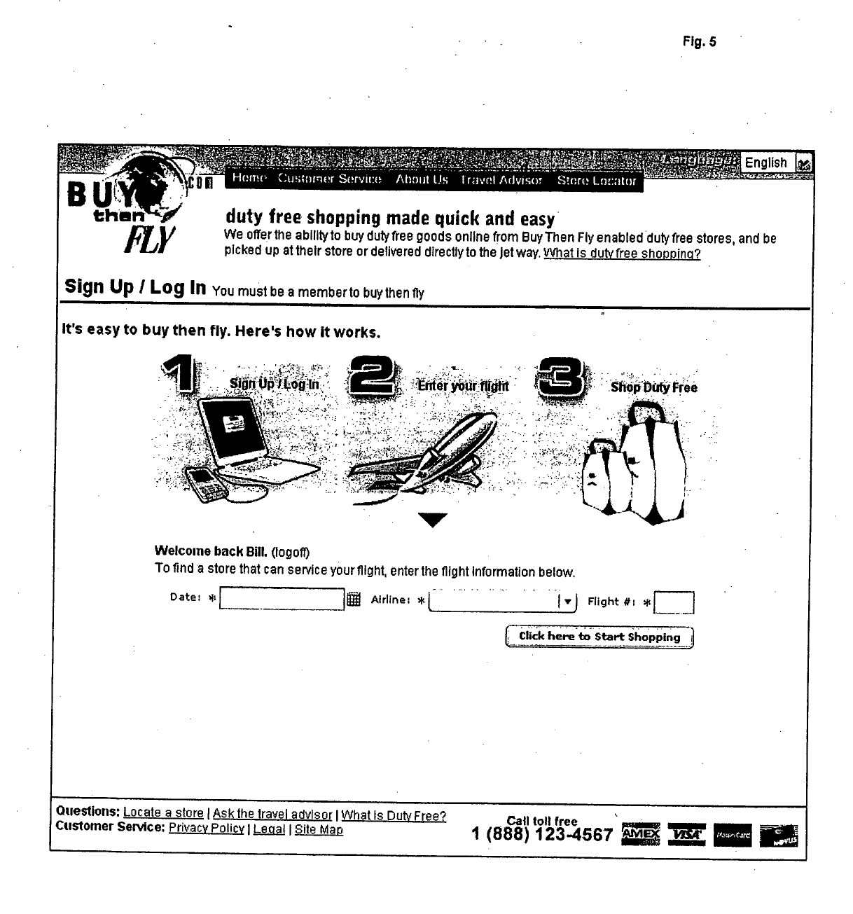

FIG. 6 depicts a sample system duty-free store screen depicting information regarding the duty-free store(s) located at the user's flight departure terminal, also displaying various duty-free goods on special promotion at such store.

FIG. 7 depicts a sample duty-free products category search screen, for searching of the duty-free goods available for purchase at the designated duty-free store.

FIG. 8 depicts a sample duty-free product inventory search screen displaying actual product items available for purchase at the designated duty-free store.

FIG. 9 depicts a sample duty-free product item selection screen providing information about particular duty-free products available for purchase at the designated duty-free store.

FIG. 10 depicts a sample shopping cart user screen depicting duty-free product items selected by a user for purchase.

FIG. 11 depicts a sample system administrative log-in screen for use by duty-free store system users to manage their system data.

FIG. 12 depicts a sample system duty-free store maintenance screen for use by duty-free store system users to manage the system screens pertaining to their duty-free store.

FIG. 13 depicts a sample system duty-free store product maintenance screen for use by duty-free store system users to manage their duty-free product inventory offerings on the system.

FIG. 14 depicts a sample system duty-free store promotion maintenance screen for use by duty-free store system users to manage their duty-free product promotional offerings on the system.

FIG. 15 is a flow chart depicting the process flow for system web-based administration by duty-free store system users.

FIG. 16 is a flow chart depicting the process flow for system web services based administration by duty-free store system users, involving duty-free store product inventory updating via world wide web data transfer in extensible markup language or other formats.

FIG. 17 is a flow chart depicting the process flow for system dynamic ad generation by duty-free store system users.

### DESCRIPTION OF A PREFERRED EMBODIMENT

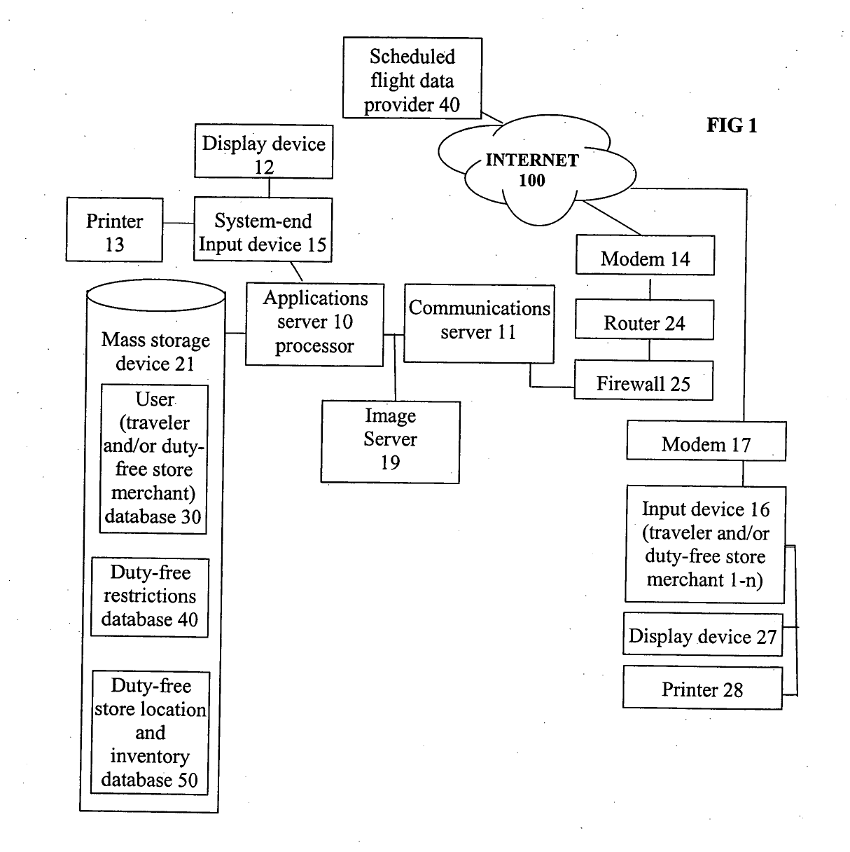

As noted previously, the invention is not limited to travel by aircraft or any other travel means, and references to air travel are for exemplary non-limiting purposes. As depicted generally in FIG. 1, the present invention is an Internet-based system for engaging in electronic commerce, involving duty-free goods, comprising one or more Internet communications servers 11 for handling of communications between the system and its users via the Internet 100, and with one or more scheduled flight data sources 40 (the scheduled flight data can optionally be housed at the system end such as at the applications servers 10 or can be accessed from external sources); one or more system application servers 10 communicating with said communications server 11 and other system-end components, which can include one or more system-end input devices 15, and one or more mass data storage devices 21. The one or more mass storage devices/servers 21 store system databases, which include a user database (users can include consumers as well as duty-free store merchants) 30, a duty-free restrictions database 40 and a duty-free store location and inventory database 50. These types of data could be stored in a single database rather than separate databases. The system-end input device 15 can be a conventional personal computer connected by cables or wires to other components, or, alternately, a wireless computer or a pda (personal digital assistant) or other input device, and can further include a printer 13 and a display device 12. The Internet communications server 11 can have a firewall 25, router/load balancer 24 and modem 14 between it and the Internet, as can the system user-end computer or other input device 16.

The hardware configuration of the system of the present invention depicted in FIG. 1 is not the only preferred embodiment, as the input devices at the system and user-ends can vary, as can the number of each of the components; however, the communications flow in each embodiment is similar. The system-end hardware comprises a conventional Internet communications web-server 11 protected by a firewall 25 between the server 11 and the Internet 100. The web-server 11 communicates with one or more system application servers 10, which store and run system software applications. An image server 19 is optionally included to provide a master file of high resolution images of duty-free products, providing image configuration/integration with screen content provided from the applications servers 10. The one or more application servers 10 communicate with one or more databases/servers 21 which store client/user and other data. The user screen images in such an embodiment are a combination of image server 19 and applications server content. The user end of the system hardware can comprise any of the various forms of communications means useable via the Internet, from personal computers having a connection to the Internet to personal digital assistants and can utilize traditional wire-based communications or wireless communication means, whether cellular-based, satellite-based or other means.

System Security

The system preferably uses state of the art encryption for all data sent to and from the system. The system is not limited to any particular scripting language and various scripting languages can be utilized without exceeding the scope of the present invention. The system communications can be encrypted and requests can be logged and tracked. Both reversible (two-way) and irreversible (one-way) encryption can be used based on the type and sensitivity of the data to ensure a secure environment for user data. The core client/user databases are preferably encrypted using reversible encryption key tokens dynamically changed on a time basis. System schemas, containing user/client meta information (i.e., usernames, passwords, credit cards, payment information) are preferably encrypted using irreversible encryption technologies, although the invention is not limited to any particular encryption technology.

The system exchanges data with a plurality of remote terminals via known methods utilized for Internet communications, namely, data transmission across telephone and data transmission lines or via wireless communication means. Data transmission on the system end utilizes a gateway that interfaces the system to remote terminals with a protocol understood by said remote terminals or intermediary equipment connected thereto. For example, in a preferred embodiment of the present system, data is transmitted to and from the system via the Internet using transmission control protocol/Internet protocol (“TCP/IP”).

System Architecture

The system stores and processes multiple databases, including one or more client/user databases 30, comprehensive duty-free goods restrictions databases 40 including database modules correlating the duty-free goods restrictions that apply to each duty-free store location, and duty-free store location and inventory databases 50.

The various databases are preferably relational and are preferably resident in a structured query language (“SQL”) database server 21. The SQL is programmed to allow searching of the database. Scheduled flight data is also provided from a database, which can be either housed within the system or accessed via the Internet 100 from another location 40.

These components are operatively connected to commonly used input/output (“I/O”) interface devices 15 that control various corresponding I/O devices. These I/O devices may include such conventional elements as one or more video display devices 12, keyboards, printers 13, mouses and digitizers or scanners.

As with other computer systems, the read-only memory of the applications server processor 10 provides software instructions to enable the application server 10 to execute necessary software applications performing the system functions, including control/interfacing with the system Internet web communications server 11, communications with remote terminals; controlling event-driven algorithms through which the system processes transactions appropriately based on the directions indicated by user action (“events”) such as pressing keys or clicking a mouse. The messaging means can be any of the various generally known forms, including, without limitation, e-mail as well as peer-to-peer and instant messaging protocols.

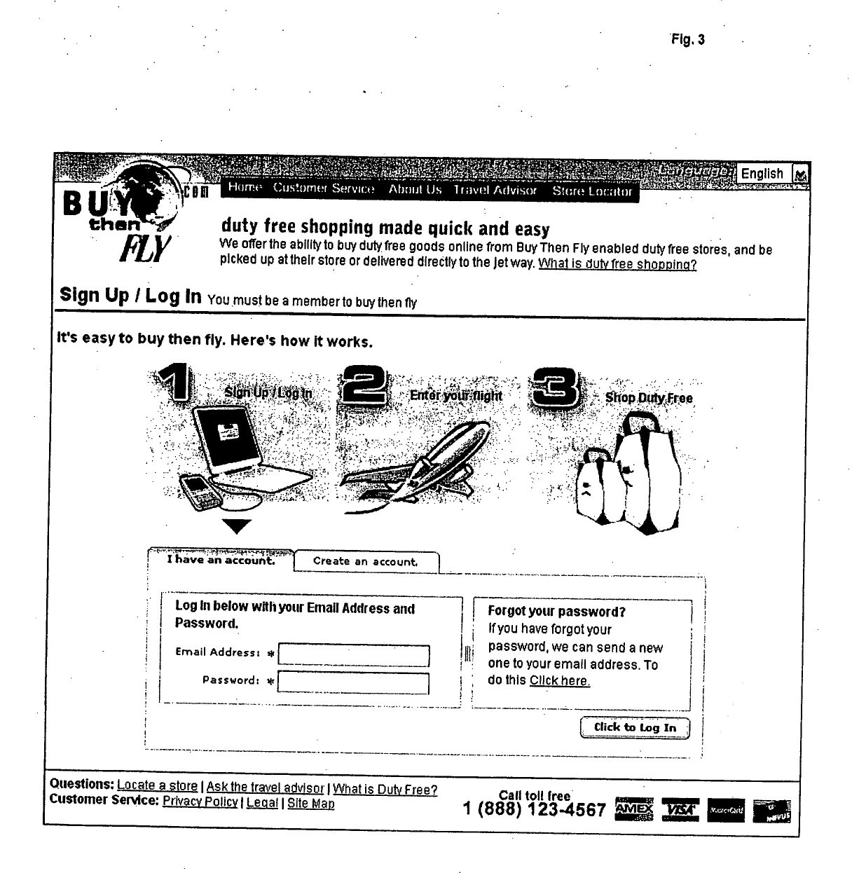

The website of the present system served by the one or more Internet web communications servers 11 in a preferred embodiment is operatively connected to the Internet 100 and has at least a first home page remotely accessible by users. FIG. 3 depicts a sample name/log-in page. Under the present system, first time users may access the system in response to a generic advertisement placed on another website, and then enter a log-in screen rather than a home page screen. Alternately, users may access the website of the present system directly and view the website homepage for options that can be selected to proceed into the system. The system, in a preferred embodiment, has a plurality of screens whereby users enter and retrieve information pertaining to duty-free goods. Certain screens are provided for use by all users, while others are provided for only for administrators. The system user screens guide users through the duty-free goods purchase process.

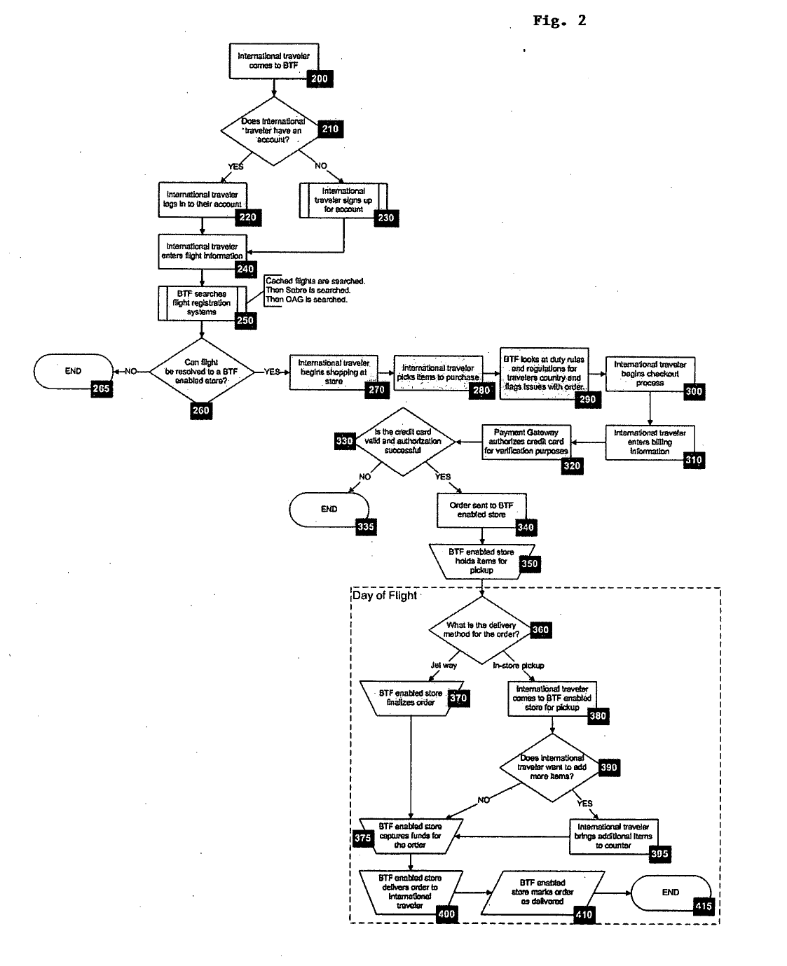

Referring to FIG. 2, which depicts the online system process flow, the first steps involve the user registration and subscription process flow. The system allows for easy sign up of new users. New users can originate from two general categories sources: travelers and duty free store merchants. In each circumstance, user logs into the system at the applicable log-in screen. FIG. 2 refers to traveler users and the system is referred to as “BTF” (Buy then Fly). The system verifies whether the user has an account with the system 210. If the user is registered with the system, the user logs in to the user's account 220. If not, the user registers with the system to obtain a user account 230. The user enters flight information 240 and the system searches flight registration data systems 250 (e.g., Sabre, OAG and/or other flight data sources), and the system determines whether there is a system store at the flight location that can service the user 260. If there is no system-enabled store at the flight location, the process ends 265. If there is a store the user is provided with a screen whereby the user can proceed to shop at the store 270. The user picks items to purchase 280 and the system reviews applicable duty-free restrictions to qualify the purchases 290. Once the user has completed shopping, the checkout/order confirmation process begins 300. The user's billing/payment information is provided 310, either by the user directly or from the user's previously stored data, as well as details regarding pickup/delivery of the order. The pickup/delivery method may be prescribed by the applicable duty-free regulations. The payment and payment form is then processed for authorization 320. Alternatively, the payment form can be used simply for authorization/verification purposes and actual payment can be taken care of at the duty-free store when delivering/picking up the purchased goods. If the payment authorization is not successful, the process ends 335. If it is successful, the order is sent to the applicable system-enabled store 340. The store then holds the items for pickup/delivery at the designated place and time 350. On the day of the flight, the delivery/pickup method for the order is verified 360. If it is a jetway delivery, the system-enabled store finalizes the order 370, collects payment 375, and completes delivery 400. The system-enabled store marks the order as delivered 410 and the process ends 415. If it is an in-store pickup, the traveler goes to the store for pickup of the purchased goods 380. The user can add items to the order while at the store 390. If the user has no additional items for purchase at the store, the store collects payment 375, delivers the goods 400, marks the order as delivered 410 and the process ends 415. If additional items are purchased while at the store, the user takes the additional items to the store counter to add to the order 395, and payment and delivery is processed as described above.

As shown in FIG. 3, users are prompted to either log-in by entering their e-mail address and password if they already have a system account, or they can create a new account. Existing users that forget their passwords can have their passwords sent to them by e-mail. Alternately, users can generate their own passwords when registering. Password size and form restrictions are used for increased security. The user interface, as depicted in FIG. 3, includes a home page button, a customer service button, an “about us” button, a travel advisor button and a duty-free store locator button. Users can also select the language in which the user interface is presented. In FIG. 3, the interface is presented in English. The credit card and other payment forms that are accepted are depicted, as are links to the system privacy policy, legal terms and site map. A questions feature is also provided, whereby users can ask various questions to the system, such as store locations, questions regarding travel advice and questions regarding duty-free regulations.

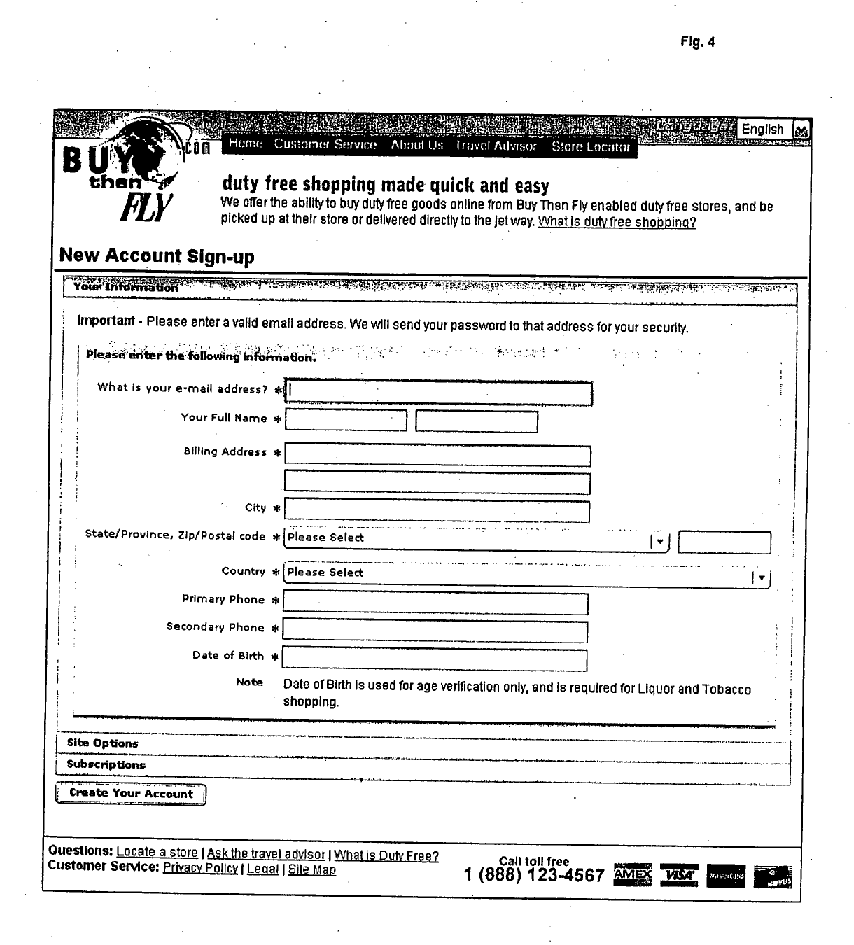

As shown in FIG. 4, new users are prompted to register with the system by providing their e-mail address, name, billing address, telephone numbers, and date of birth for purposes of age verification for liquor and tobacco shopping. As shown in FIG. 4, the user is provided with subscreens providing site options and system user subscription terms. The user may also be prompted to read and accept the system's online terms and conditions of use. Once the user has registered with the system and accepted the terms of use, the system validates the information and then either sends a newly generated system user password to the user via e-mail to the user's designated e-mail address, or if the user created his or her own password, an activation confirmation is sent. If a user later enters the password incorrectly or if the password is deactivated, the user is denied access to the system.

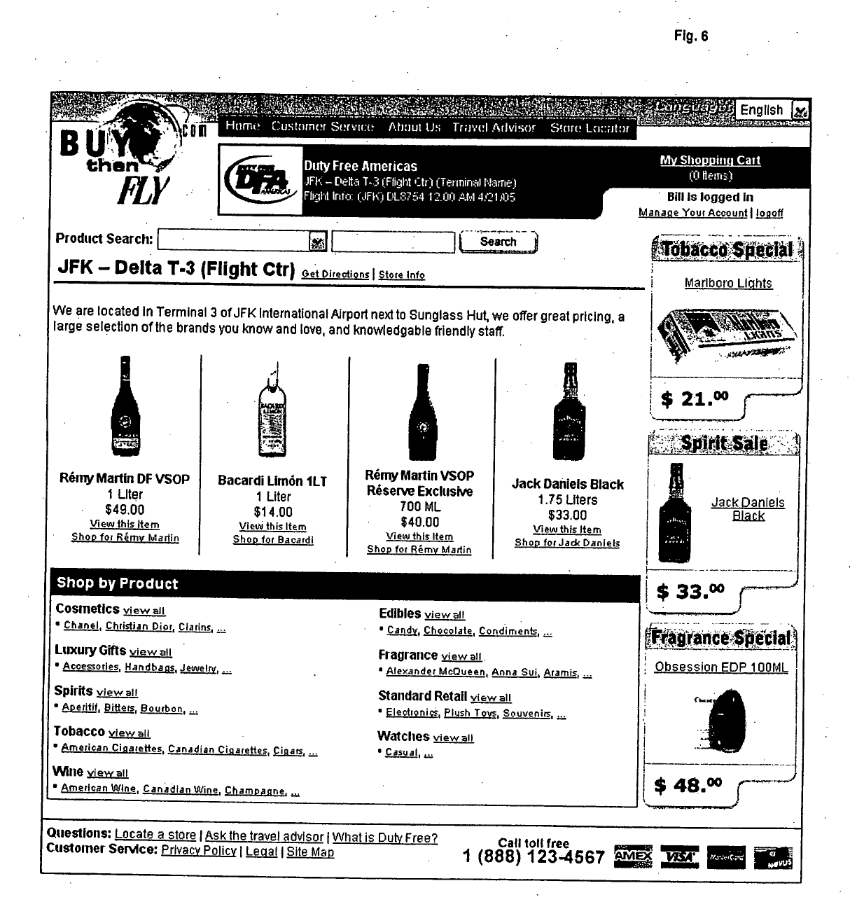

Once a user is logged into the system, the user is presented with a screen in the form of FIG. 4, where the user is welcomed by his or her first name and prompted to enter the user's flight information, by date, airline and flight number, in order for the system to provide information regarding the duty-free stores that can service the user's flight. Once the flight information is entered, the system provides the information pertaining to the duty-free store(s) that the user can purchase from at the flight's airport terminal, as depicted in FIG. 6. FIG. 6 shows at the top the applicable duty-free store (e.g., Duty Free Americas) as well as the airport and terminal location and the flight information previously entered by the user. The screen also includes the particular duty-free store's advertised promotions for particular duty free goods. There is a shopping cart feature which tracks the user's purchase selections as well as links providing additional information about the particular duty-free store, directions on how to get to the store. As shown in FIG. 6, users can shop by product category or select items on promotion.

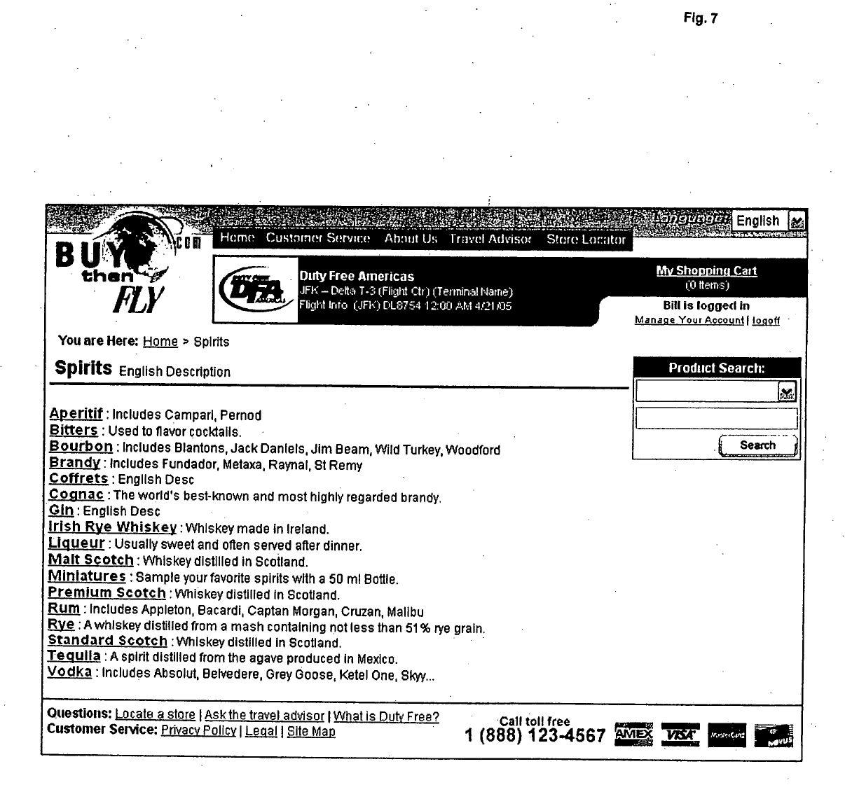

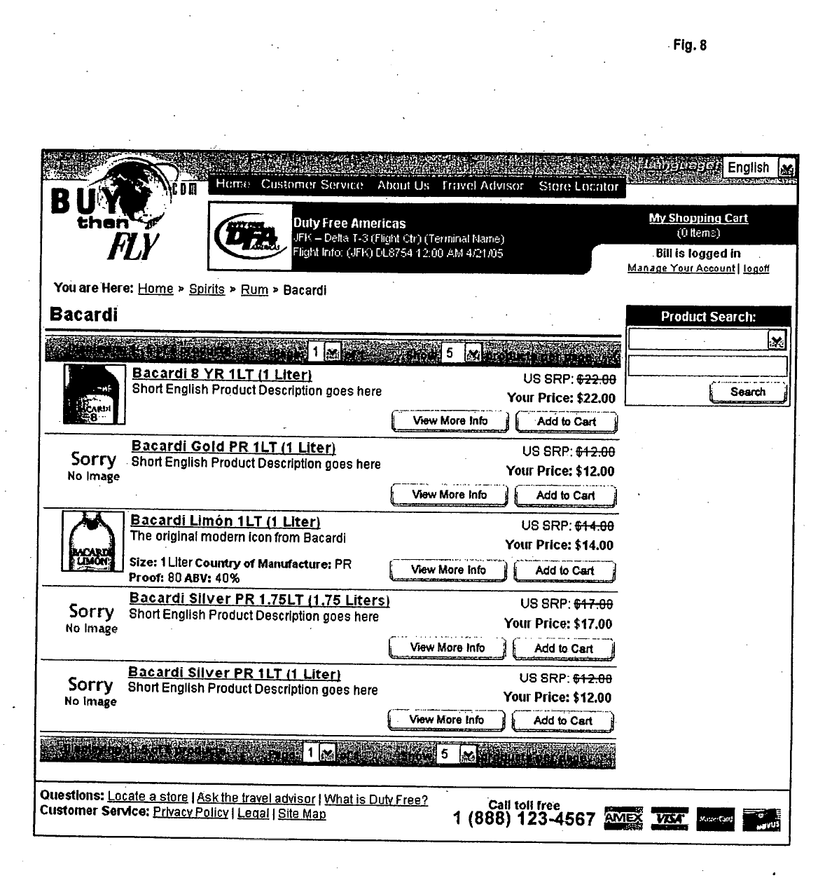

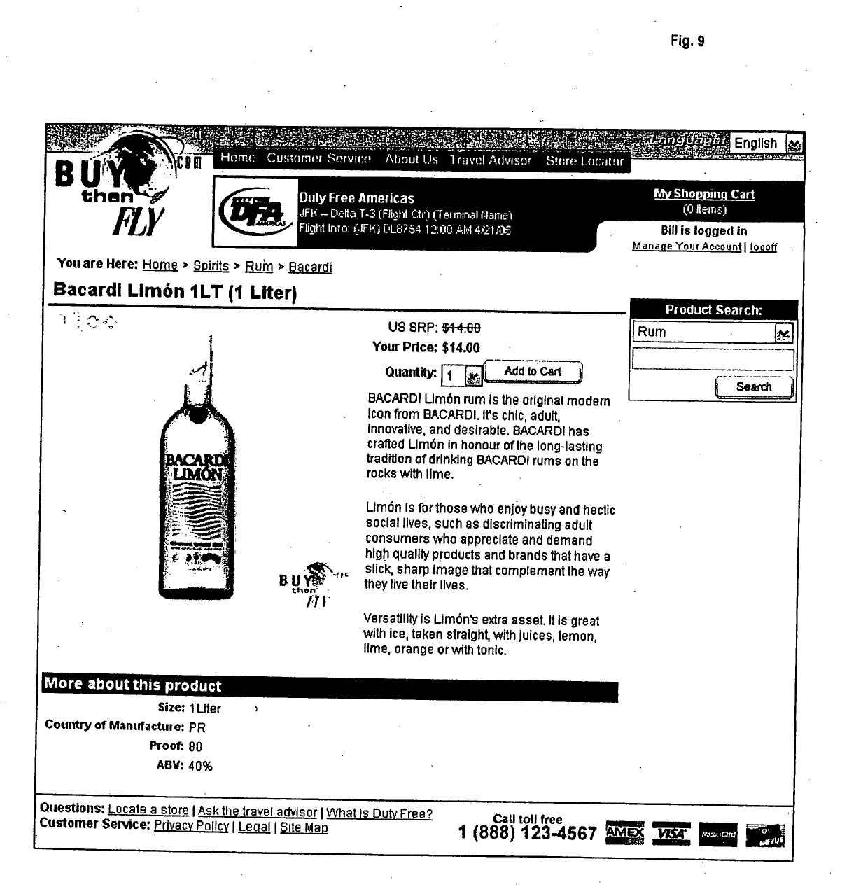

As shown in FIG. 7, the system provides multiple product category hierarchies for users to search for products as well as specific product name searching capabilities. When a user selects a specific named product or drills down the product categories, the system provides listings of specific products available for purchase at the specified duty-free store, as depicted in FIG. 8. The “you are here” line shows the sample search progression, such as in the example in FIG. 8, from “home” page, to the “spirits” category, to the “rum” category, then to the “Bacardi” category. As shown in FIG. 8, visual depictions of the products can be provided, as well as quantity, country of manufacture, proof, and price information. Buttons are provided for the user to view more info and to add products to the user's shopping cart. FIG. 9 depicts another product screen providing more extensive information for a particular listed duty-free product.

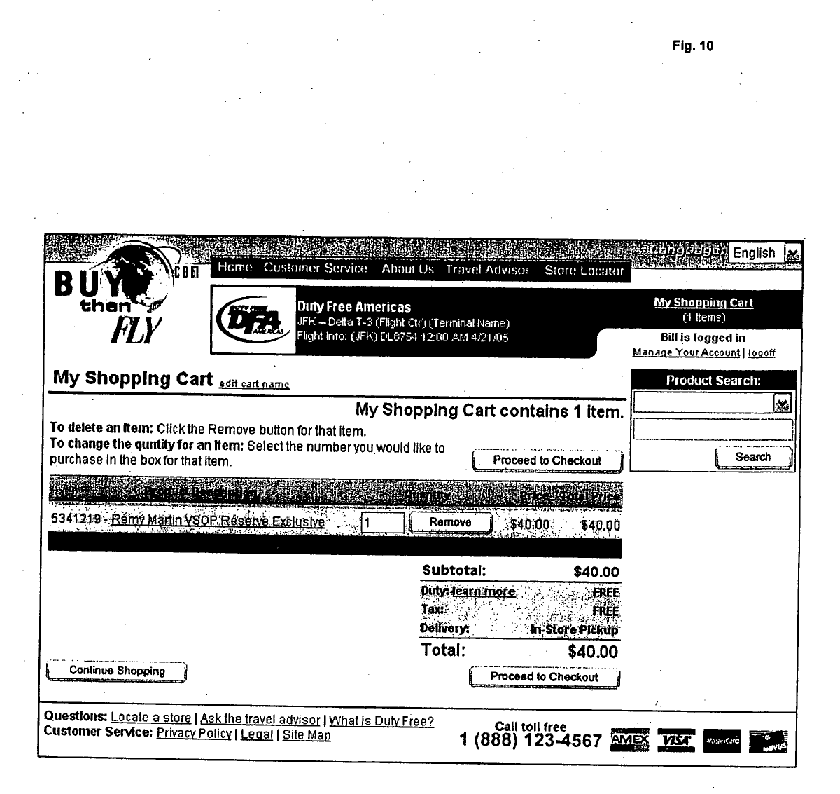

FIG. 10 depicts a sample user shopping cart screen, which lists the items selected for purchase and provides the ability to delete items or change the quantity of items to be purchased. As shown in FIG. 10, the shopping cart screen also provides a subtotal, a well as any applicable duty amounts and the method of delivery, as well as a running total amount. Buttons are also provided for the user to either continue shopping or proceed to check out. The “My Shopping Cart” line keeps a total of the number of items selected.

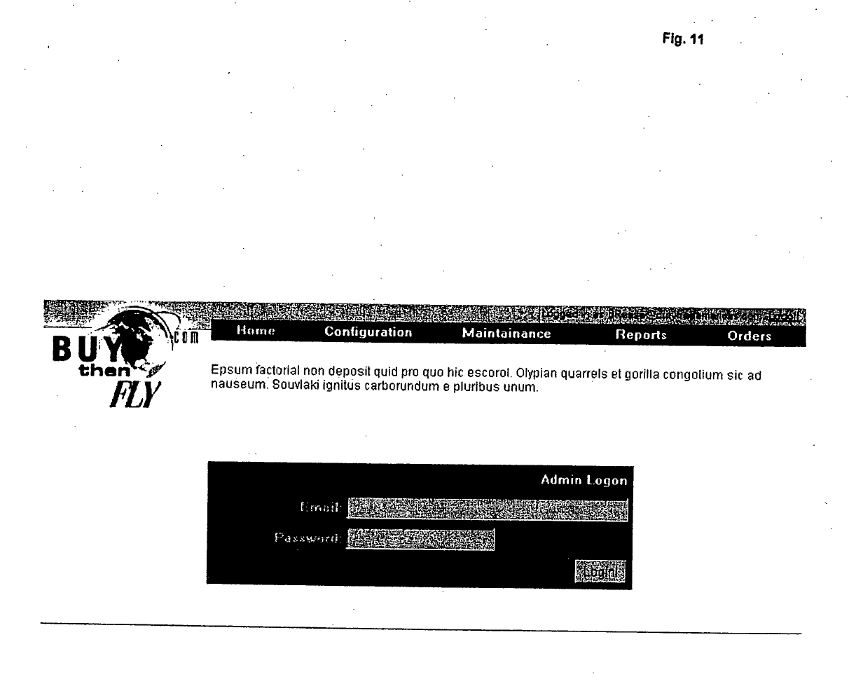

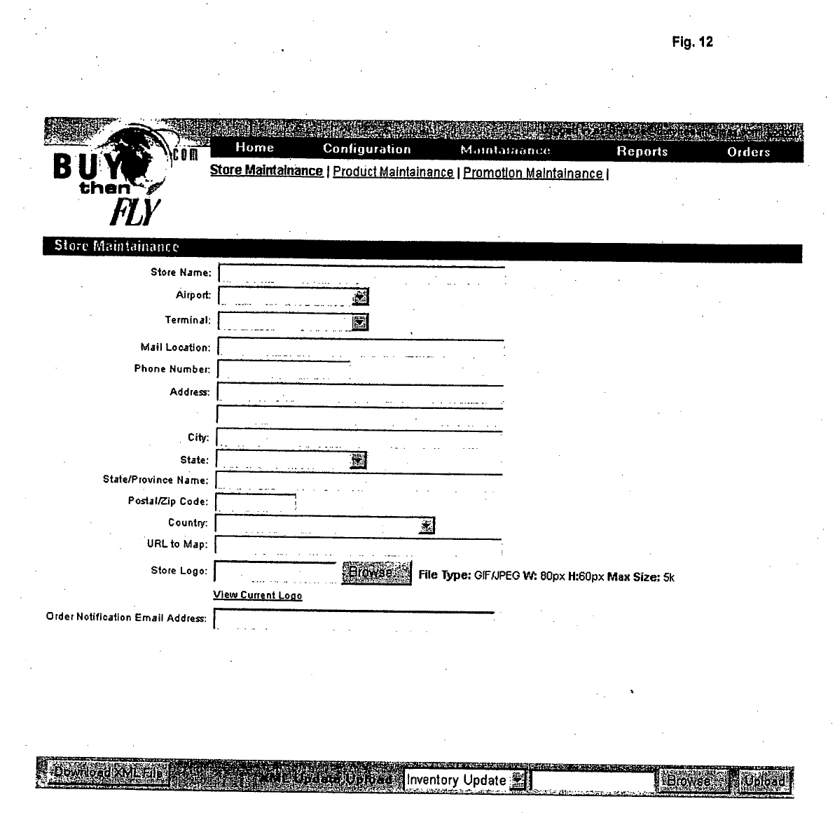

As noted previously, the system is also used directly by the duty-free store merchants to engage in e-commerce by providing their store's duty-free goods inventory, price and promotional offerings data to the system for retrieval by the traveler/consumer users of the system. FIG. 11 depicts a sample administrative login screen for duty-free store merchants to use to log into the system to provide, update and maintain their store and duty-free products inventory and promotions information. The duty-free store merchant maintenance screens are preferably divided into store maintenance, product maintenance and promotion maintenance screens, as shown in FIG. 12. There are also home, configuration, reports and orders screens, as represented by the buttons depicted at the top of the screen shown in FIG. 12, whereby merchants can configure their pages and obtain usage and sales reports and order data. As shown in FIG. 12, the store maintenance screen is where the store location information is provided, as well as a link to a map for finding the store, order notification e-mail address information, and store logo and other graphics to be presented on the system screens for the particular store. As shown in FIG. 12 at the bottom toolbar, duty-free store merchants using the system can upload inventory data files to the system for retrieval and presentation to traveler consumer users. The uploads can be in various forms, including, without limitation, in extensible markup language or “XML” format, via the Internet. Alternatively, XML files can be sent to a web services-enabled URL for more automatic processing of updates.

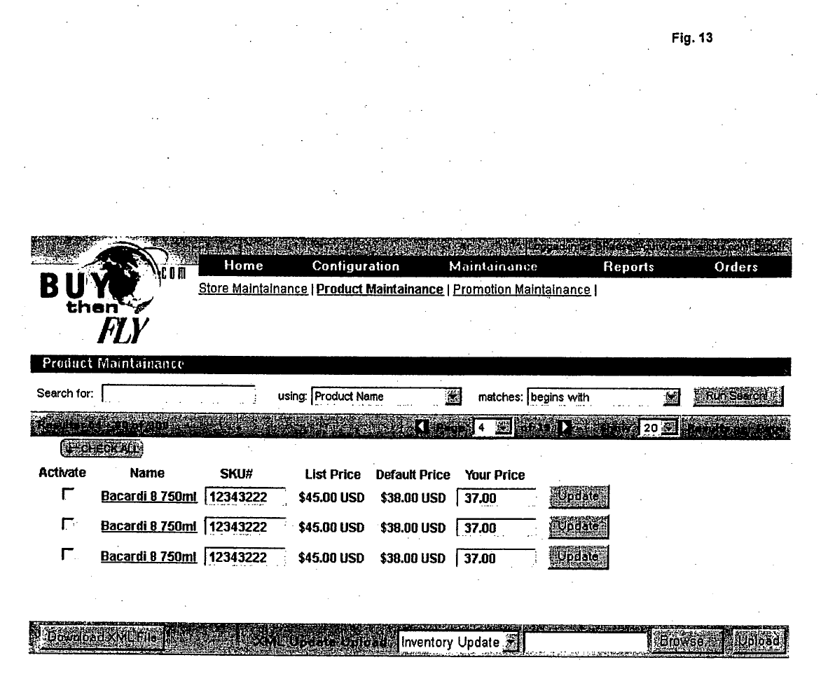

FIG. 13 depicts a sample product maintenance screen whereby duty-free store merchants can update their product listings by product, SKU number and price, among other features. Product listing data can be pulled up by duty-free store merchants by searches, as shown in FIG. 13 under the “Product Maintenance” heading.

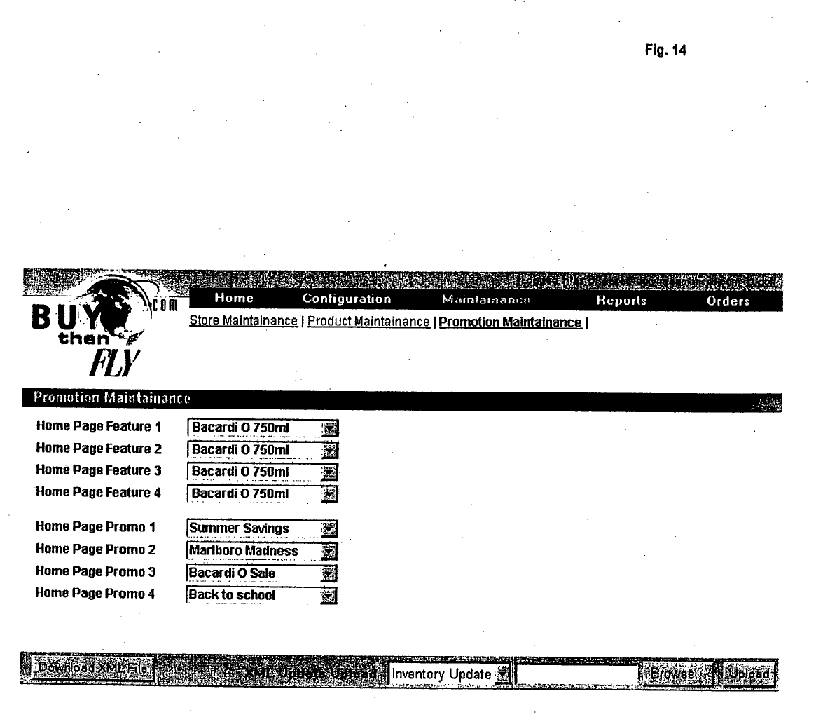

Duty-free store merchant system users can also update their system store home page promotional offerings by accessing the promotion maintenance screen as shown in FIG. 14.

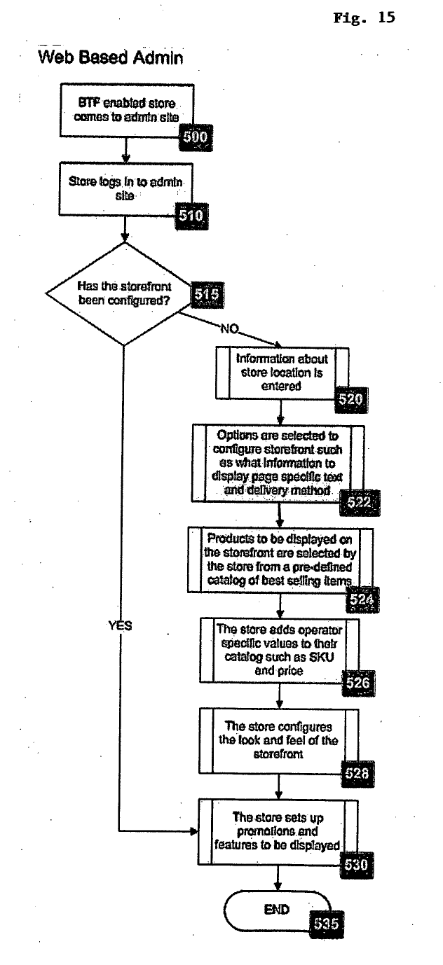

The process flow for duty-free store merchant web-based administration of the system is depicted in FIG. 15. The system-enabled store first accesses the administrative page of the site as shown in step 500. The merchant logs into the administrative site 510. If the store screens have been previously configured, the merchant can proceed to set up and update promotions and features to be displayed 530. If not, then information pertaining to the store location is entered 520. Options are selected to configure the merchant's storefront, such as, for example, the information to be displayed on each page and the data delivery method to be used 522. Products to be displayed on the storefront are selected by the merchant from a pre-defined catalog of items 524. The merchant can add specific pricing and SKU number information for the products 526 and can configure the look and feel of the “storefront” pages on the system 528, and thereafter can also set up promotions and features to be displayed 530.

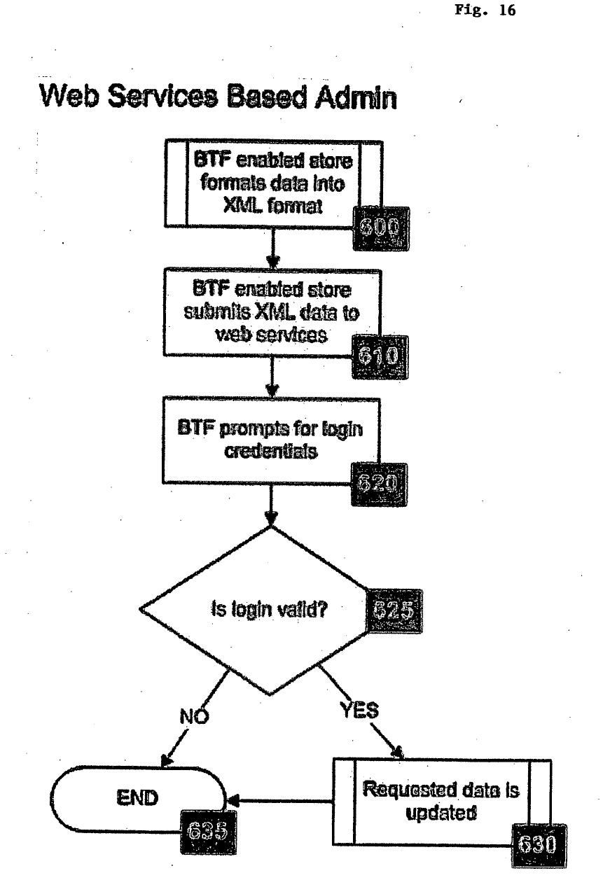

If the duty-free store merchant desires, it can also upload its inventory data via the Internet. XML or other formats can be utilized for this purpose. The process flow is shown in FIG. 16. The merchant first formats the data into the desired format 600 (which is XML in the example given in FIG. 16.) The data is then submitted to the system's web services 610. The merchant is prompted for log-in credentials 620. If the credentials are validated, the data is updated 630.

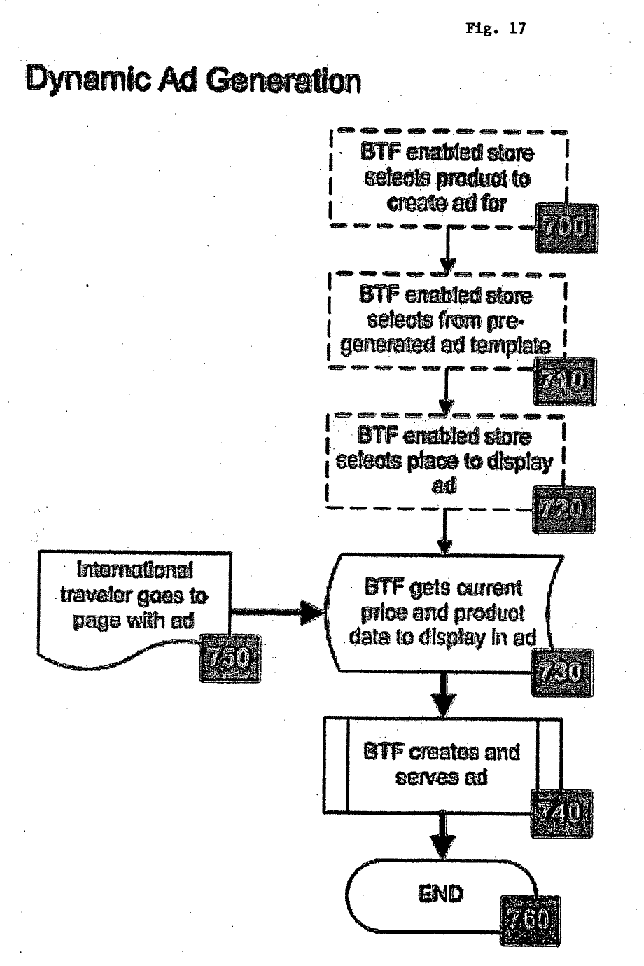

FIG. 17 depicts the process flow for duty-free store merchants to dynamically generate ads for their store and products. The merchant selects the product to create an ad for 700 and also selects from various pre-generated ad templates provided by the system 710. The merchant then selects where to place the ad 720. The system then provides the product data and current price from the merchant's data 730 and then creates and serves the ad 740. Consumer users can then view the ad when they use the system 750.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative and other embodiments may be selected without departing from the spirit and scope of the present invention.

What is claimed is:

1. An Internet-based duty-free goods electronic commerce system comprising:
one or more Internet communications servers for Internet-based communications with system consumer users, travel transportation method data sources, duty-free merchants and other system participants;
one or more system application servers comprising computer processor means at the system-end for processing communications to and from said Internet communications server and system-end databases, software applications and other system-end elements;
one or more data storage devices communicating with said one or more system applications servers which store one or more databases including data regarding system users, duty-free rules and restrictions data applicable to various arrival and departure points, and information about duty-free goods available for purchase at various arrival and departure points;
one or more system software applications run by said applications server computer processor providing a graphical user interface and content for system consumer users and duty-free merchants to input data and transact with the system;
a user-end input device communicating with said Internet communications server for system users to input data regarding user identification, travel transportation method information, arrival and departure points, information pertaining to duty-free goods to be purchased, and payment form information.

2. The system of claim 1, further comprising one or more travel transportation means data sources.

3. The system of claim 1, further comprising a merchant-end input device communicating with the system's Internet communications server for said merchants to provide information pertaining to said merchants' duty-free goods to said system for review by said consumer users and engage in electronic commerce with respect to said duty-free goods with said consumer users.

4. The system of claim 3, wherein said system software applications enable said duty-free merchant system users to create online promotions for duty-free goods.

5. The system of claim 1, further comprising an image server providing high resolution images of duty-free goods, providing image configuration and integration with said graphical user interface screen content provided by said one or more system application servers.

6. The system of claim 1, wherein said travel method is aircraft travel.

7. The system of claim 1, wherein said travel method is ocean vessel travel.

8. The system of claim 1, wherein said travel method is land vehicle travel.

9. The system of claim 1, wherein said system software applications provide notification to system users of duty-free goods sales promotions.

10. A method for engaging in electronic commerce involving duty-free goods, comprising the following steps:
receiving and verifying a consumer user's travel information;
identifying one or more duty-free stores located at or near said consumer user's travel departure or arrival point;
identifying the duty-free restrictions applicable to purchases from said one or more duty-free stores for importation into said consumer user's home country or other arrival point;
providing information regarding the duty-free goods available for purchase from said one or more duty-free stores;
processing consumer duty-free goods purchase selections and payment for same; and
fulfilling said purchases.

11. The method of claim 10, wherein said consumer user plans to travel by aircraft and said consumer user's travel information comprises consumer personal identification data, aircraft flight number, date and time of departure and departure and arrival points.

12. The method of claim 10, wherein said consumer user plans to travel by sea and said consumer user's travel information comprises consumer personal identification data, ship data and time of departure and departure and arrival points.

13. The method of claim 10, wherein said consumer user plans to travel by land and said consumer user's travel information comprises consumer personal identification data, data and time of departure and departure and arrival points.

14. The method of claim 10, wherein said order fulfillment is accomplished by delivery of the purchased duty-free goods to said consumer user at said consumer user's travel method boarding point.

15. The method of claim 11, wherein said order fulfillment is accomplished by delivery of the purchased goods to said consumer user at said consumer user's departure point jet way.

16. The method of claim 12, wherein said order fulfillment is accomplished by delivery of the purchased duty-free goods to said consumer at said consumer's ocean vessel boarding area.

17. The method of claim 10, wherein said order fulfillment is accomplished by pickup of said purchased duty-free goods by said consumer user at the designated duty-free store.

18. The method of claim 10, wherein payment for said purchased duty-free goods is made at the delivery/pickup point rather than at the time of ordering.

19. An Internet-based duty-free goods electronic commerce system comprising:
one or more Internet communications servers for Internet-based communications with system consumer users, travel transportation method data sources, duty-free merchants and other system participants;
one or more travel transportation means data sources;
one or more system application servers comprising computer processor means at the system-end for processing communications to and from said Internet communications server and system-end databases, software applications and other system-end elements;
one or more data storage devices communicating with said one or more system applications servers which store one or more databases including data regarding system users, duty-free rules and restrictions data applicable to various arrival and departure points, and information about duty-free goods available for purchase at various arrival and departure points;
one or more system software applications run by said applications server computer processor providing a graphical user interface and content for system consumer users and duty-free merchants to input data and transact with the system;
means for system consumer users to input data regarding user identification, travel transportation method information, arrival and departure points, information pertaining to duty-free goods to be purchased, and payment form information; and
means for duty-free goods merchants to provide information pertaining to said merchants' duty-free goods to said system for review by said consumer users and engage in electronic commerce with respect to said duty-free goods with said consumer users.
